(19) United States
(12) Patent Application Publication
(10) Pub. No.: US 2022/0018810 A1
(43) Pub. Date: Jan. 20, 2022

(54) CHARACTERIZING INTERNAL STRUCTURES VIA ULTRASOUND

(71) Applicant: THE BOEING COMPANY, Chicago, IL (US)

(72) Inventors: Jill P. BINGHAM, Seattle, WA (US); Gary E. GEORGESON, Tacoma, WA (US); Barry A. FETZER, Renton, WA (US)

(21) Appl. No.: 17/365,553

(22) Filed: Jul. 1, 2021

Related U.S. Application Data
(60) Provisional application No. 63/052,431, filed on Jul. 15, 2020.

(51) Int. Cl. G01N 29/04; G01N 29/06

(52) U.S. Cl. CPC G01N 29/041; G01N 29/069

(57) ABSTRACT

The present disclosure provides for characterizing internal structures via ultrasound by inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized. In some aspects, the ultrasonic test wave is induced by a laser inducer and/or received by a laser interferometer. The test signature includes one or more of: frequency responses, amplitude responses, and times of flight. The test signature can be used to identify changes in a component over time, verify similarity between different components, monitor thermal processes, and verify an identify of a component.

### CROSS-REFERENCES TO RELATED APPLICAIONS

The present disclosure claims priority to U.S. Provisional Patent Application No. 63/052,431 filed on Jul. 15, 2020, which is incorporated herein by reference in its entirety.

### FIELD

Aspects of the present disclosure relate to ultrasound inspection. More particularly, aspects relate to characterizing internal structures of a component via ultrasound inspection.

### BACKGROUND

Internal structures can significantly affect the mechanical properties of a component or structure, but are not readily apparent for inspection. Examples of internal structures that affect the mechanical properties of a component include: the grain size in a metal; the positioning of steel bars within concrete; the presence of knots, rot, or growth rings in wood; thicknesses and compositions of layers in a laminate material; etc. Various destructive tests, such as x-ray diffraction, core-sampling, etc., can be used in a laboratory setting to examine internal structures. Nondestructive tests are needed when testing components or structures that will be put into use after inspection.

### SUMMARY

The present disclosure provides a method in one aspect, the method including: inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized.

In one aspect, in combination with any example method above or below, the test signature is developed based on a time of flight and an attenuation amplitude signal response of the ultrasonic test wave through the component.

In one aspect, in combination with any example method above or below, the test signature is developed based on a frequency response of the ultrasonic test wave through the component.

In one aspect, in combination with any example method above or below, the internal feature characterized by the comparison includes at least one of a grain size, grain orientation, and a grain morphology of the component, and wherein the baseline signature is established based on a database of test result signals corresponding to known grain patterns.

In one aspect, in combination with any example method above or below, the ultrasonic test wave is induced by a laser.

In one aspect, in combination with any example method above or below, the ultrasonic test wave is induced on a first surface of the component and is selected from a group consisting of: a surface wave, traveling along the first surface from a first location to a second location; a shear wave, traveling from the first location on the first surface through the component to a second surface opposite to the first surface, and back to the first surface at the second location; and a transverse wave, traveling from a third location on the first surface through the component to the second surface, and back to the first surface at the third location.

In one aspect, in combination with any example method above or below, characterizing an internal feature further comprises gating received signals at various times of signal reception to correspond to various depths in the component from a surface in which the ultrasonic test wave is induced.

The present disclosure provides a system in one aspect, the system including: a processor; and a memory including instructions that when executed by the processor enable the system to perform an operation comprising: inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized.

In one aspect, in combination with any example system above or below, the test signature is developed based on a time of flight and an attenuation amplitude signal response of the ultrasonic test wave through the component.

In one aspect, in combination with any example system above or below, the test signature is developed based on a frequency response of the ultrasonic test wave through the component.

In one aspect, in combination with any example system above or below, the internal feature characterized by the comparison includes at least one of a grain size, grain orientation, and a grain morphology of the component, and wherein the baseline signature is established based on a database of test result signals corresponding to known grain patterns.

In one aspect, in combination with any example system above or below, the ultrasonic test wave is induced collected by a laser interferometer.

In one aspect, in combination with any example system above or below, the ultrasonic test wave is induced on a first surface of the component and comprises: a surface wave, traveling along the first surface from a first location to a second location; a shear wave, traveling from the first location on the first surface through the component to a second surface opposite to the first surface, and back to the first surface at the second location; and a transverse wave, traveling from a third location on the first surface through the component to the second surface, and back to the first surface at the third location.

In one aspect, in combination with any example system above or below, characterizing an internal feature further comprises gating received signals at various times of signal reception to correspond to various depths in the component from a surface in which the ultrasonic test wave is induced.

The present disclosure provides a computer-readable storage device in one aspect, the computer-readable storage device including instructions that when executed by a processor enable the processor perform an operation comprising: inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized.

In one aspect, in combination with any example computer-readable storage device above or below, the test signature is developed based on a time of flight and an attenuation amplitude signal response of the ultrasonic test wave through the component.

In one aspect, in combination with any example computer-readable storage device above or below, the test signature is developed based on a frequency response of the ultrasonic test wave through the component.

In one aspect, in combination with any example computer-readable storage device above or below, the internal feature characterized by the comparison includes at least one of a grain size, grain orientation, and a grain morphology of the component, and wherein the baseline signature is established based on a database of test result signals corresponding to known grain patterns.

In one aspect, in combination with any example computer-readable storage device above or below, the ultrasonic test wave is induced on a first surface of the component and comprises: a surface wave, traveling along the first surface from a first location to a second location; a shear wave, traveling from the first location on the first surface through the component to a second surface opposite to the first surface, and back to the first surface at the second location; and a transverse wave, traveling from a third location on the first surface through the component to the second surface, and back to the first surface at the third location.

In one aspect, in combination with any example computer-readable storage device above or below, characterizing an internal feature further comprises gating received signals at various times of signal reception to correspond to various depths in the component from a surface in which the ultrasonic test wave is induced.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIGS. 1A and 1B illustrate several travel paths for ultrasound waves induced in a component, according to aspects of the present disclosure.

FIG. 2 illustrates a waveform for an ultrasonic wave generated in a component as measured by an ultrasound receiver, according to aspects of the present disclosure.

FIG. 3 is a flowchart of a method for characterizing internal structures in a component via ultrasound, according to aspects of the present disclosure.

FIG. 4 illustrates a computing device, according to aspects of the present disclosure.

### DETAILED DESCRIPTION

The present disclosure provides for ultrasound testing of various components to develop and apply a signature (also referred to as a “fingerprint”) to identify and track various internal structures of the components. An ultrasound test device (UTD) induces various ultrasonic waves in the component (including one of more of longitudinal waves, surface waves, lateral waves, and shear waves) and analyses the propagating waves to identify various internal features of the component by the propagation speeds, signal attenuation (e.g., absorption, amplitude decreases, scattering), and changes in frequencies of the signals. The UTD can correlate the resultant waves to various internal features and/or identify changes in the internal structure over time based on earlier readings from the same component or other components with the same internal structures. Accordingly, a user can apply an ultrasound in a nondestructive inspection (NDI) to identify and track features internal to a component.

Although the examples given herein primarily relate to metallic components, in which the internal structures include various features of the grains within those metallic components (e.g., sizes, orientations, morphologies of the grains), the present disclosure is not limited to applications in which the component is metallic, or where the internal structure relates to the grains within that metal. Indeed, the present disclosure can be applied with any solid material, including: ceramic materials, biological or natural materials (e.g., wood, bone, tooth, horn, natural rubber), plastic or synthetic materials (e.g., various plastics, synthetic rubber, carbon fiber), mineral materials (e.g., fossils, gems, stones), laminates, textiles, and composite materials including two or more different examples of the aforementioned materials to analyze the various internal structures thereof (including the grains thereof, inclusions therein, voids therein, etc.).

Additionally, although the examples given herein primarily relate to performing NDI on components or structures that are subjected to various external loads or forces when used (e.g., the wings of an aircraft, a truss of a bridge, the walls of a pressure vessel, the hull of a ship), the present disclosure can be applied with components or structures that are not subjected to external loads or forces in everyday use (e.g., a lens of a camera, a circuit board, a work of art, an artifact).

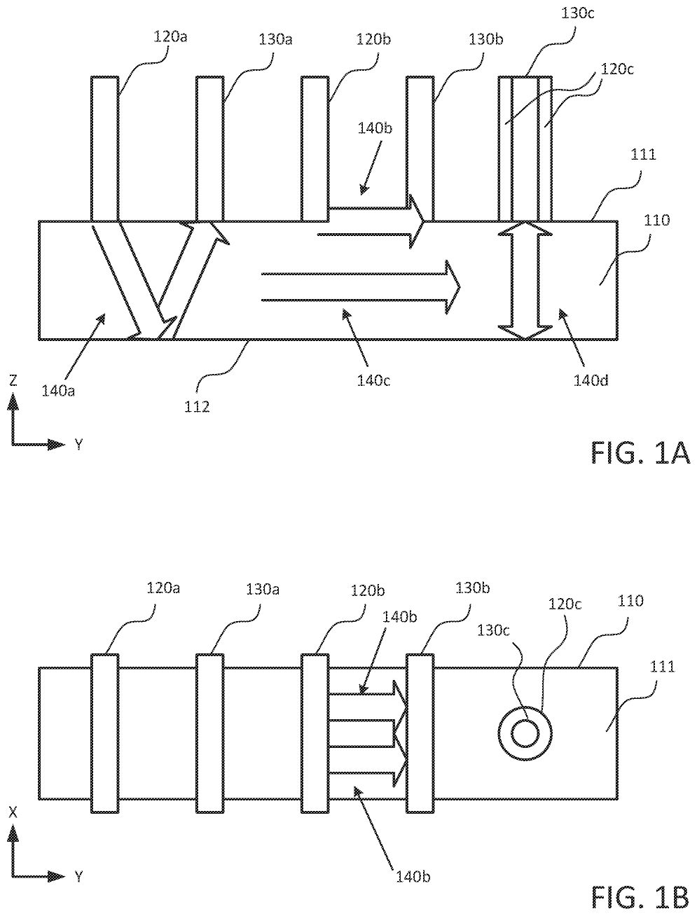

FIGS. 1A and 1B illustrate several travel paths for ultrasound waves induced in a component 110, according to aspects of the present disclosure. FIG. 1A illustrates a component 110 in cross-sectional view in the ZY plane, and FIG. 1B illustrates that component 110 in the XY plane. Several ultrasound inducers 120a-c (generally or collectively, ultrasound inducers 120) and corresponding ultrasound receivers 130a-c (generally or collectively, ultrasound receivers 130) are shown in relation to the component 110 and the various wave modes 140a-c of the ultrasonic wave produced and measured by the ultrasound inducers 120a-c and ultrasound receivers 130a-c.

The component 110 includes a first surface 111 on which the one or more ultrasound inducers 120 induce various ultrasound waves that one or more ultrasound receivers 130a-c measure the waveforms therefrom, and a second surface 112 opposite to the first surface 111, which can reflect various waveforms back to the first surface 111 for measurement.

In some aspects, the ultrasound inducers 120 induce the ultrasonic waves directly on the first surface 111 and the ultrasound receivers 130 measure the ultrasonic waves directly from the first surface 111. In other aspects, an intermediary couplant (such as an oil, water, glycerin, or a gel) separates the ultrasound inducers 120 and/or ultrasound receivers 130 from the first surface 111 and helps reduce reflection from the first surface 111 and direct more acoustic energy into the component 110.

In some aspects, the ultrasound inducers 120 include piezoelectric transducers or electromagnetic acoustic transducers that convert an electrical signal into an acoustic wave which is transferred to the component 110 and analyzed by the ultrasound receivers 130.

In various aspects, the ultrasound inducers 120 include lasers, which generate a laser beam to induce ultrasonic waves in the component 110 via thermal expansion and/or ablation and recoil. The ultrasound receivers 130 can similarly include piezoelectric receivers or electromagnetic acoustic transducers that convert an acoustic wave received from the first surface 111 to an electrical signal for measurement, and laser receivers that measure vibrations in the component 110 (and/or surrounding medium) due to the acoustic waves induced by the ultrasound inducer 120. For example, a laser interferometer can be used as an ultrasound receiver 130 to collect the ultrasonic test wave(s) induced in the material by one or more ultrasound inducers 120.

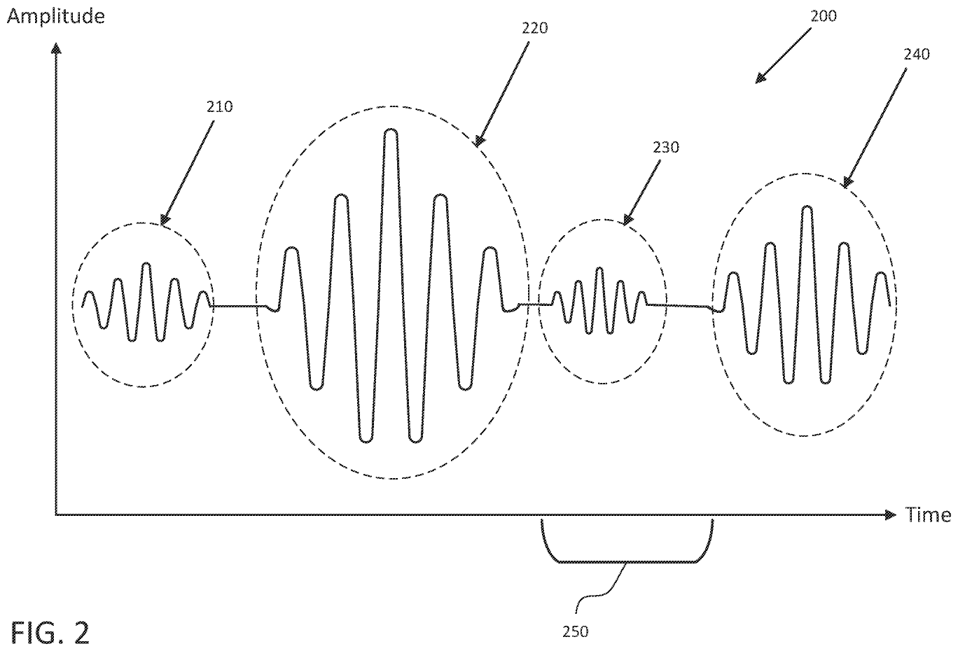

In various aspects, the inducers/receivers are paired together so that a given ultrasound receiver 130 is configured to receive and measure some or all of the ultrasonic waves generated by a given ultrasound inducer 120 (e.g., 120a/130a, 120b/130b, 120c/130c). The ultrasound receivers 130 can electronically gate what portions of the received waveforms are analyzed to distinguish between various waveforms (as is discussed in greater detail in regard to FIG. 2) and what depth in the material of the component 110 is analyzed. In some aspects, the inducers/receivers include separated transducers (such as the first and second ultrasound inducers 120a, 120b and the first and second ultrasound receivers 130a, 130b) that induce and measure ultrasound waves at different locations (e.g., in the Y direction) on the component to measure structural features between the different locations. In various aspects, inducers/receivers include point transducers (such as the third ultrasound inducer 120c and the third ultrasound receiver 130c) that induce and measure ultrasound waves at or around the same location on the component 110 to measure structural features in the depth direction (e.g., in the Z direction).

The inducers/receivers can be arranged in arrays or used singularly in various aspects. For example, in FIG. 1B, the third inducer/receiver 120c/130c is shown as a singular transducer that can be moved in the X and Y directions to take different measurements of the component in the Z direction. FIG. 1B also shows the second inducer/receiver 120b/130b as an arrayed transducer that can generate and measure multiple waves when located at a given position, allowing a two dimensional scan of the component to be developed.

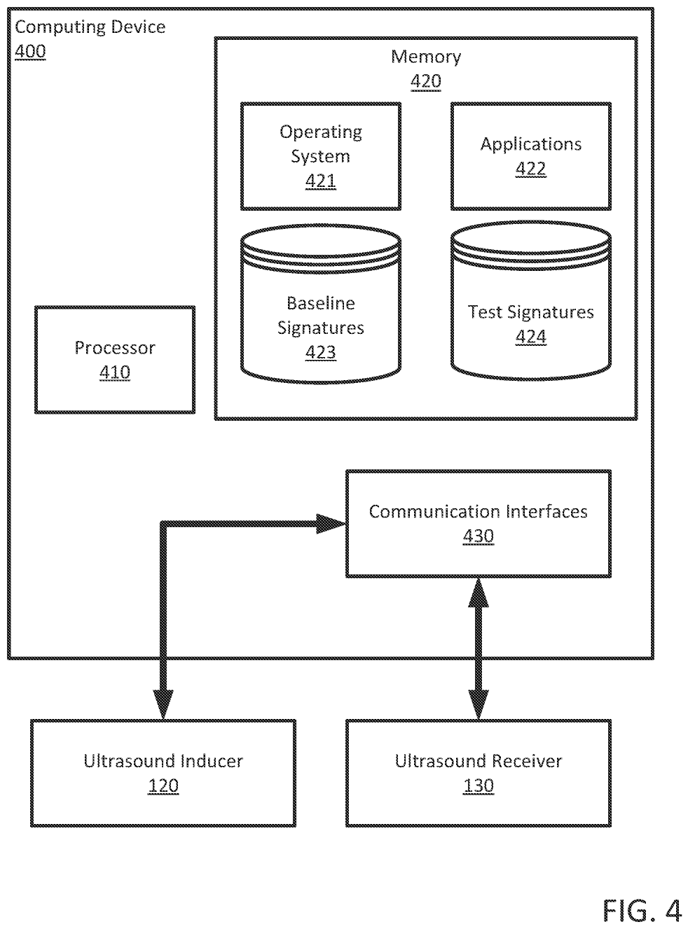

A computing device (such as the computing device 400 discussed in relation to FIG. 4) can combine several readings taken at the same or different times to form various scans to characterize the internal structures of the component 100.

For example, each ultrasound wave that is generated and received can be used for an A-scan, which is a one dimensional representation of the travel of the wave through the component 110, and several A-scans can be grouped together to form a B-scan, which is a two-dimensional cross-sectional representation of the component 110 generated from the A-scans. When the first surface is in the XY plane, the A-scans represent the travel of the waves in the Z direction, and the B-scans represent a cross-sectional view in the XZ plane. The computing device can amalgamate (and gate based on distance from the first surface 111 to the desired signal) several B-scans to generate a C-scan, which represents a cross-sectional view of the component 110 in the XY plane. B-scans and C-scans can provide detailed information about the size and location of various structural features in the component 110 to characterize the internal features.

The ultrasound inducers 120 and ultrasound receivers 130 can be configured (via construction and/or angle relative to the first surface 111) to produce and measure various different modes of a generated ultrasound wave to produce the various scans. Although each paired set of ultrasound inducers 120 and ultrasound receivers 130 is shown inducing one corresponding wave mode 140a-c, it will be appreciated that each ultrasound inducer 120a-c can generate one or several different wave types and that each ultrasound receiver 130a-c can receive and measure one or several different wave modes, and the individual wave modes 140a-c are illustrated separately for clarity of explanation.

Depending on the type of material undergoing NDI, the frequencies used in the induced ultrasound waves can vary. For example, when inspecting metallic components, frequencies can vary from approximately 2 MHz (megahertz) to 10 MHz (±10%), and when inspecting components made from a less-dense material (e.g., wood, stone, steel-reinforced cement), lower frequencies can be used (e.g., 50-500 kHz (kilohertz)±10%). Notably, these are just some examples ranges for some example materials, and others are possible.

In FIG. 1A, the first ultrasound inducer 120a and the first ultrasound receiver 130a are illustrated as sending and receiving a shear wave 140a. The shear wave 140a is generated on the first surface 111 at a first location that travels through the body of the component 110 to the second surface 112, and reflects back to the first surface 111 at a second location, where the first ultrasound receiver 130a measures the shear wave 140a. The shear wave 140a can be induced at various angles relative to the first surface 111, and allows for the first ultrasound receiver 130a to measure the internal structures of the component 110.

In FIGS. 1A and 1B, the second ultrasound inducer 120b and the second ultrasound receiver 130b are illustrated sending and receiving longitudinal waves. The longitudinal waves include a surface wave 140b that travels along the first surface 111 (up to a depth of one wavelength in some examples) from a first location to a second location, and a structural wave 140c that travels deeper below the first surface 111 (in excess of one wavelength) from the first location to the second location, where the second ultrasound receiver 130b measures the longitudinal waves. Surface waves 140b allow for the second ultrasound receiver 130b to measure surface features, and can follow the first surface 111 over curved portions thereof. The structural waves 140c travel parallel to the first surface 111, and allow for the second ultrasound receiver 130b to measure the internal features of the component 110.

Although shown as generating and receiving a shear wave 140a, in various aspects, the first ultrasound inducer 120a is angled relative to the first surface 111 to also produce longitudinal waves. As will be understood with reference to Snell's law, the angle of the first ultrasound inducer 120a relative to the first surface 111 and the refraction indices of the component 110 (and any couplant between the first ultrasound inducer 120a and the component 110) determines whether the induced wave reflects off of the first surface 111 or is refracted into the component 110. In various aspects, the angle of the ultrasound inducer 120 incident to the first surface 111 is set to be at or below the critical angle to produce (via a single ultrasound inducer 120) both shear waves 140a and longitudinal waves on the first surface 111. By providing both shear and longitudinal waves from a single ultrasound inducer 120, the ultrasound receiver 130 is provided with a greater amount of information about the component 110 than if the ultrasound inducer 120 were angled so as to remove or avoid inducing longitudinal waves.

In FIG. 1A, the third ultrasound inducer 120c and the third ultrasound receiver 130c are illustrated as sending and receiving a transverse wave 140d. The transverse wave 140d is generated on the first surface 111 at a third location that travels through the body of the component 110 to the second surface 112, and reflects back to the first surface 111 at a third location, where the third ultrasound receiver 130c measures the transverse wave 140d. The transverse wave 140d is induced perpendicular to the first surface 111, and allows for the first ultrasound receiver 130a to measure the internal structures of the component 110 at a specific portion of the component 110.

FIG. 2 illustrates a waveform 200 for an ultrasonic wave generated by an ultrasound inducer 120 in a component 110 as measured by an ultrasound receiver 130 (such as are discussed in relation to FIGS. 1A and 1B), according to aspects of the present disclosure. The waveform 200 is illustrated in the time and amplitude domains, but it will be understood that the waveform 200 can be presented in various other domains (e.g., frequency).

As an induced wave travels through a component, the path that the wave travels and the internal structure of that component along that path affect the wave in various waves. For example, traveling a longer path generally results in the wave arriving at a destination point at a later time than a wave traveling a shorter path to the destination; however, propagation speeds through a component can be affected by the frequency of the wave and/or various inclusions with different propagation speeds. In further examples, various internal structures can scatter the waves, affect the frequencies of the waves, attenuate the amplitudes of the waves, and two or more waves can interfere with one another if traveling over at least a portion of the same path through the component. Accordingly, the amplitude, time of flight, frequency, and location of reception of an ultrasound wave relative to the induced ultrasound wave can all provide information about the internal structure and features of a component.

In the illustrated waveform 200, several segments 210-240 are illustrated that represent different modes of the induced wave(s) that are received at different times. The several segments 210-240 can represent different transmission pathways to the receiver, from one or more inducers. For example, the first segment 210 can include a first shear wave generated by a first inducer and the second segment 220 can include a first surface wave generated by the same first inducer. Continuing the example, the third segment 230 can include a second shear wave generated by a second inducer and the fourth segment 240 can include a second surface wave generated by the second inducer, which have reflected or otherwise propagated through the component to be received by the first receiver.

The ultrasound test device (UTD) can select which segment of the received signal is of interest for further analysis by applying a gate 250 to the signal, thereby selecting a portion of the waveform 200 to develop a signature or fingerprint for the component from (and ignoring or using the unselected portions in a different signature/fingerprint). The gate 250 can be a variable data gate that is configurable to select different portions of the signal that are of interest for characterization and thereby develop a test signature based on the portion of the test signal according to one or more of a time of flight, an amplitude signal response, and a frequency signal response of the ultrasonic test wave though the component.

As shown in FIG. 2, the gate 250 has been applied to select the third segment 230, but an operator can reapply the gate 250 by changing the duration and/or timing of the gate 250 to select additional or different segments in different aspects. By setting the gate 250 at various times within the waveform 200, an operator can analyze the received signals that correspond with various depths within the component based on the portions of the ultrasonic test wave included within the gate 250 and the paths which those waves traveled through the component.

In various aspects, the UTD can compensate for signal background noise in the received waves based on the characteristics of the originally induced wave and/or the expected characteristics of the received wave given the composition of the component being scanned. For example, the UTD can consider the frequency response of two waveforms induced in the component with different frequencies and normalize the frequencies of the two signals based on signal attenuation over the signal pathway to compensate for noise in the frequency responses of the signals.

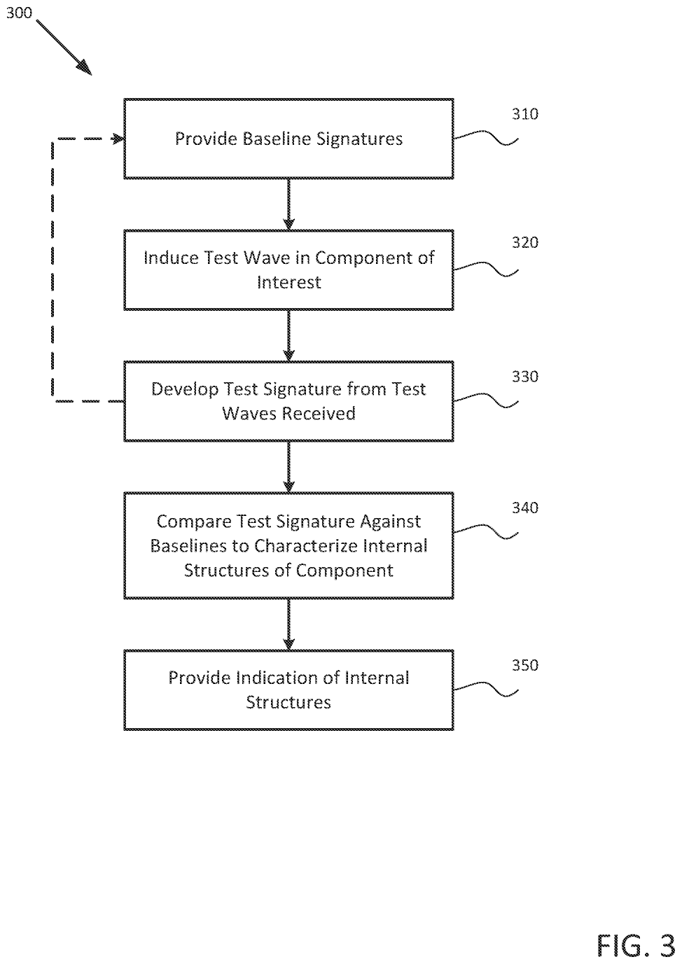

FIG. 3 is a flowchart of a method 300 for characterizing internal structures in a component via ultrasound, according to aspects of the present disclosure. Method 300 begins with block 310, where a database of baseline signature is provided for a component. In various aspects, the baseline signature is an earlier provided NDI test result (e.g., a test signature developed per blocks 320 and 330 of an earlier performance of method 300) for the component, or can be an NDI test result from a different component that is known to exhibit a given internal structure. The baseline signature can include various wave patterns, A-scans, B-scans, and C-scans that are used to compare against test waves induced and measured in a component during NDI.

At block 320, the UTD induces test waves in a component of interest. In various aspects, the UTD can induce several test waves which can use different ultrasonic frequencies (depending on the material of the component), be induced at different locations on the component, and produce different wave modes for analysis. The UTD can induce the test waves via one or more ultrasound inducers 120 (as discussed in FIGS. 1A and 1B), which can include lasers, piezoelectric transducers or electromagnetic transducers. The inducers induce the test waves on a first surface of the component, and the test waves can include various propagation modes to allow for inspection of different portions of the component. Some examples of the wave modes include: surface waves that travel along the first surface (up to a depth of one wavelength) from a first location to a second location; shear waves that travel from a first location on the first surface through the component to a second surface opposite to the first surface, and back to the first surface at a second location; and transverse waves that travel from a first location on the first surface through the component to the second surface, and back to the first surface at the first location.

At block 330, the UTD develops a test signature from the test waves induced in the component. Various ultrasound receivers receive and measure the test waves propagating through the component to develop various scans of the component. In various aspects, the UTD gates the received and measured test waves to measure specific portions of the received waveform to develop a test signature (or a portion thereof) for a selected wave mode and/or wave path through the component.

The UTD can characterize the test waves using several techniques. In some aspects, the UTD develops the test signature based on the time of flight of the test waves through the component (i.e., from the inducer to the receiver) and the amplitude signal response and/or attenuation of the test wave through the component (i.e., a difference between induced and received amplitudes of the test wave). In some aspects, the UTD develops the test signature based on the frequency response of the test waves through the component (i.e., a difference between induced and received frequencies of the test wave).

The scans developed as a test signature (per block 330) can include various A-scans, which are combined into various B-scans or C-scans as part of NDI of the component and/or for use as a baseline signature for a later NDI, which the UTD compares against one or more of the baseline signatures (provided per block 310) at block 340. At block 340, the UTD characterizes an internal feature of the component based on the comparison between the baseline and test signatures for the component.

The UTD can select one or more baseline signatures to compare against the test signature, which can include looking for matches between known baseline signatures and an unknown test signature (e.g., to verify an identity of the component), looking for changes over time from previously captured test signatures and a current test signature for one component, and comparing different instances of a component with known internal features against an instance of the component with (currently) unknown internal features.

When comparing the signatures, the UTD aligns the baseline and test signatures with one another (e.g., based on a known origin point for the NDI, locational features or “landmarks” on the component, etc.) to ensure that the portions of the test signature are compared against corresponding portions in the baseline signatures.

Internal features that can be characterized by the comparison in a metallic component include, but at not limited to: grain size, grain orientation, grain morphology of the component, and wherein the baseline signature is established based on a database of test result signals corresponding to known grain patterns. Some additional examples of internal features that can be characterized include supports or inclusions (e.g., stones, support beams, meshes, etc.,) within a composite material, layer thicknesses and waviness in a laminate component, voids or air pockets within the component, grain size/orientation/morphology of a wooden or other biological component, etc.

At block 350, the UTD provides an indication of the internal structures. In various aspects, the indication is provided as one or more images (e.g., the B-scans or C-scans) that indicate the internal structures, or that highlight the differences between the baseline and test signatures. In some aspects, the indications include alerts for when a change is present between a baseline signature of a prior test signature and the current test signature or when the test signature matches a baseline signature associated with a given internal structure. In some aspects, the indications include alerts for when a test signature matches a given baseline signature (e.g., when the inspected component matches a previously inspected component, or includes internal features that match a known-good component).

FIG. 4 illustrates a computing device 400, according to aspects of the present disclosure. FIG. 4 illustrates example computing components of a computing device 400 or other processing system as may be used to perform NDI on various components by characterizing the internal structures thereof.

The computing device 400 includes a processor 410, a memory 420, and an interface 430. The processor 410 and the memory 420 provide computing functionality to run various programs and/or operations for the respective computing device 400, including the storage and retrieval of the various data described herein.

The processor 410, which may be any computer processor capable of performing the functions described herein, executes commands based on inputs received from a user and the data received from the interface 430.

The interface 430 connects the computing device 400 to external devices, such as, for example, external memory devices, external computing devices, a power source, a wireless transmitter, etc., and may include various connection ports (e.g., Universal Serial Bus (USB), Firewire, Ethernet, coaxial jacks) and cabling. The interface 430 is used to send and receive between computing devices 400 and manage the generation of ultrasound waves by one or more ultrasound inducers 120 and to receive and measure ultrasound waves by one or more ultrasound receivers 130. The interface 430, ultrasound receiver(s) 130, and/or software running on the computing device 400 or another device can amplify, clean, and manipulate data related to the received ultrasound waves to develop various scans of a component for analysis thereof.

The memory 420 is a computer-readable storage device that generally includes various processor-executable instructions, that when executed by the processor 410, perform the various functions related to characterizing internal structures via ultrasound as discussed herein. The processor-executable instructions may generally be described or organized into various “applications” or “modules” in the memory 420, although alternate implementations may have different functions and/or combinations of functions. The memory 420 also generally includes data structures that store information for use by or output by the various applications or modules. In the present disclosure, the memory 420 includes at least instructions for an operating system 421, one or more application(s) 422, baseline signatures 423, and test signatures 424. The memory 420 may be one or more memory devices, such as, for example, Random Access Memory (RAM), Read Only Memory (ROM), flash memory, or any other type of volatile or non-volatile storage medium that includes instructions that the processor 410 may execute.

When the computing device 400 provides the functionality of an UTD, the memory 420 includes processor executable instructions to provide the functionalities thereof described in the present disclosure. In some aspects, the memory 420 includes databases for locally caching data that include listings or databases that identify the waveforms and baseline signatures 423 for earlier scans of a given component or profiles for various structural elements that can be compared against test signatures 424 to characterize the current internal structures of a component undergoing NDI.

A further understanding of at least some of the aspects of the present disclosure is provided with reference to the following numbered Clauses, in which:

Clause 1: A method comprising: inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized.

Clause 2: A method as in any one of clauses 1 and 3-7, wherein the test signature is developed based on a time of flight and an attenuation amplitude signal response of the ultrasonic test wave through the component.

Clause 3: A method as in any one of clauses 1, 2, and 4-7, wherein the test signature is developed based on a frequency response of the ultrasonic test wave through the component.

Clause 4: A method as in any one of clauses 1-3 and 5-7, wherein the internal feature characterized by the comparison includes at least one of a grain size, grain orientation, and a grain morphology of the component, and wherein the baseline signature is established based on a database of test result signals corresponding to known grain patterns.

Clause 5: A method as in any one of clauses 1-4, 6, and 7, wherein the ultrasonic test wave is induced by a laser.

Clause 6: A method as in any one of clauses 1-6 and 7, wherein the ultrasonic test wave is induced on a first surface of the component and is selected from a group consisting of: a surface wave, traveling along the first surface from a first location to a second location; a shear wave, traveling from the first location on the first surface through the component to a second surface opposite to the first surface, and back to the first surface at the second location; and a transverse wave, traveling from a third location on the first surface through the component to the second surface, and back to the first surface at the third location.

Clause 7: A method as in any one of clauses 1-6, wherein characterizing an internal feature further comprises gating received signals at various times of signal reception to correspond to various depths in the component from a surface in which the ultrasonic test wave is induced.

Clause 8: A system comprising: a processor; and a memory including instructions that when executed by the processor enable the system to perform an operation comprising: inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized.

Clause 9: A system as in any one of clauses 8 and 10-14, wherein the test signature is developed based on a time of flight and an attenuation amplitude signal response of the ultrasonic test wave through the component.

Clause 10: A system as in any one of clauses 8, 9, and 11-14, wherein the test signature is developed based on a frequency response of the ultrasonic test wave through the component.

Clause 11: A system as in any one of clauses 8-10 and 12-14, wherein the internal feature characterized by the comparison includes at least one of a grain size, grain orientation, and a grain morphology of the component, and wherein the baseline signature is established based on a database of test result signals corresponding to known grain patterns.

Clause 12: A system as in any one of clauses 8-11, 13, and 4, wherein the ultrasonic test wave is induced collected by a laser interferometer.

Clause 13: A system as in any one of clauses 8-12 and 14, wherein the ultrasonic test wave is induced on a first surface of the component and comprises: a surface wave, traveling along the first surface from a first location to a second location; a shear wave, traveling from the first location on the first surface through the component to a second surface opposite to the first surface, and back to the first surface at the second location; and a transverse wave, traveling from a third location on the first surface through the component to the second surface, and back to the first surface at the third location.

Clause 14: A system as in any one of clauses 8-13, wherein characterizing an internal feature further comprises gating received signals at various times of signal reception to correspond to various depths in the component from a surface in which the ultrasonic test wave is induced.

Clause 15: A computer-readable storage device including instructions that when executed by a processor enable the processor perform an operation comprising: inducing an ultrasonic test wave in a component; developing a test signature based on measured propagation of the ultrasonic test wave through the component; characterizing an internal feature of the component based a comparison between the test signature and a baseline signature for the component; and providing an indication of the internal feature as characterized.

Clause 16: A computer-readable storage device as in any one of clauses 15 and 17-20, wherein the test signature is developed based on a time of flight and an attenuation amplitude signal response of the ultrasonic test wave through the component.

Clause 17: A computer-readable storage device as in any one of clauses 15, 16, and 18-20, wherein the test signature is developed based on a frequency response of the ultrasonic test wave through the component.

Clause 18: A computer-readable storage device as in any one of clauses 15-17, 19 and 20, wherein the internal feature characterized by the comparison includes at least one of a grain size, grain orientation, and a grain morphology of the component, and wherein the baseline signature is established based on a database of test result signals corresponding to known grain patterns.

Clause 19: A computer-readable storage device as in any one of clauses 15-18 and 20, wherein the ultrasonic test wave is induced on a first surface of the component and comprises: a surface wave, traveling along the first surface from a first location to a second location; a shear wave, traveling from the first location on the first surface through the component to a second surface opposite to the first surface, and back to the first surface at the second location; and a transverse wave, traveling from a third location on the first surface through the component to the second surface, and back to the first surface at the third location.

Clause 20: A computer-readable storage device as in any one of clauses 15-19, wherein characterizing an internal feature further comprises gating received signals at various times of signal reception to correspond to various depths in the component from a surface in which the ultrasonic test wave is induced.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
inducing an ultrasonic test wave in a component;
developing a test signature based on measured propagation of the ultrasonic test wave through the component;
characterizing an internal feature of the component based a comparison between the test signature and a baseline signature for the component; and
providing an indication of the internal feature as characterized.

2. The method of claim 1, wherein the test signature is developed based on a time of flight and an amplitude signal response of the ultrasonic test wave through the component.

3. The method of claim 1, wherein the test signature is developed based on a frequency response of the ultrasonic test wave through the component.

4. The method of claim 1, wherein the internal feature characterized by the comparison includes at least one of a grain size, grain orientation, and a grain morphology of the component, and wherein the baseline signature is established based on a database of test result signals corresponding to known grain patterns.

5. The method of claim 1, wherein the ultrasonic test wave is induced by a laser.

6. The method of claim 1, wherein the ultrasonic test wave is induced on a first surface of the component and is selected from a group consisting of:
a surface wave, traveling along the first surface from a first location to a second location;
a shear wave, traveling from the first location on the first surface through the component to a second surface opposite to the first surface, and back to the first surface at the second location; and
a transverse wave, traveling from a third location on the first surface through the component to the second surface, and back to the first surface at the third location.

7. The method of claim 1, wherein characterizing an internal feature further comprises gating received signals at various times of signal reception to correspond to various depths in the component from a surface in which the ultrasonic test wave is induced.

8. A system, comprising:
a processor; and
a memory including instructions that when executed by the processor enable the system to perform an operation comprising:
inducing an ultrasonic test wave in a component;
developing a test signature based on measured propagation of the ultrasonic test wave through the component;
characterizing an internal feature of the component based a comparison between the test signature and a baseline signature for the component; and
providing an indication of the internal feature as characterized.

9. The system of claim 8, wherein the test signature is developed based on a time of flight and an amplitude signal response of the ultrasonic test wave through the component.

10. The system of claim 8, wherein the test signature is developed based on a frequency response of the ultrasonic test wave through the component.

11. The system of claim 8, wherein the internal feature characterized by the comparison includes at least one of a grain size, grain orientation, and a grain morphology of the component, and wherein the baseline signature is established based on a database of test result signals corresponding to known grain patterns.

12. The system of claim 8, wherein the ultrasonic test wave is collected by a laser interferometer.

13. The system of claim 8, wherein the ultrasonic test wave is induced on a first surface of the component and comprises:
a surface wave, traveling along the first surface from a first location to a second location;
a shear wave, traveling from the first location on the first surface through the component to a second surface opposite to the first surface, and back to the first surface at the second location; and
a transverse wave, traveling from a third location on the first surface through the component to the second surface, and back to the first surface at the third location.

14. The system of claim 8, wherein characterizing an internal feature further comprises gating received signals at various times of signal reception to correspond to various depths in the component from a surface in which the ultrasonic test wave is induced.

15. A computer-readable storage device including instructions that when executed by a processor enable the processor perform an operation comprising:
inducing an ultrasonic test wave in a component;
developing a test signature based on measured propagation of the ultrasonic test wave through the component;
characterizing an internal feature of the component based a comparison between the test signature and a baseline signature for the component; and
providing an indication of the internal feature as characterized.

16. The computer-readable storage device of claim 15, wherein the test signature is developed based on a time of flight and an amplitude signal response of the ultrasonic test wave through the component.

17. The computer-readable storage device of claim 15, wherein the test signature is developed based on a frequency response of the ultrasonic test wave through the component.

18. The computer-readable storage device of claim 15, wherein the internal feature characterized by the comparison includes at least one of a grain size, grain orientation, and a grain morphology of the component, and wherein the baseline signature is established based on a database of test result signals corresponding to known grain patterns.

19. The computer-readable storage device of claim 15, wherein the ultrasonic test wave is induced on a first surface of the component and comprises:
a surface wave, traveling along the first surface from a first location to a second location;
a shear wave, traveling from the first location on the first surface through the component to a second surface opposite to the first surface, and back to the first surface at the second location; and
a transverse wave, traveling from a third location on the first surface through the component to the second surface, and back to the first surface at the third location.

20. The computer-readable storage device of claim 15, wherein characterizing an internal feature further comprises gating received signals at various times of signal reception to correspond to various depths in the component from a surface in which the ultrasonic test wave is induced.
